(19) United States
(12) Patent Application Publication
(10) Pub. No.: US 2011/0079934 A1
(43) Pub. Date: Apr. 7, 2011

(54) Manufacture of polyvinylchloride articles

(76) Inventor: Robert A. Lindner, North Wales, PA (US)

(21) Appl. No.: 12/928,244

(22) Filed: Dec. 7, 2010

Related U.S. Application Data
(63) Continuation of application No. 11/183,573, filed on Jul. 18, 2005, now abandoned.

(51) Int. Cl. B29C 43/24; C08F 110/02; C08L 27/06

(52) U.S. Cl. 264/130; 525/333.7; 525/239

(57) ABSTRACT

The present invention describes an advantageous way of lubricating polyvinylchloride during an extrusion process.

### BACKGROUND OF THE INVENTION

1. Field of the Invention

This invention relates to the manufacture of polyvinylchloride articles.

2. Description of the Art Practices

U.S. Pat. No. 4,425,458 issued Jan. 10, 1984 to Lindner describes the use of polyguerbet alcohol esters as lubricants for polycarbonate.

In U.S. Pat. No. 4,336,176 issued Jun. 22, 1982, to Lindner, there is disclosed manufacture of polyvinylchloride compounds utilizing an organo-tin compound and a partial ester having functionality as both an internal lubricant and a co-stabilizer for the plastic.

U.S. Pat. No. 4,690,977 to Hosoi et al, issued Sep. 1, 1987, describes vinylchloride polymers comprising a grafted copolymer, the vinylchloride polymer, a rubber copolymer, and a lubrication system which includes a wax lubricant and epoxidized soybean oil. Hosoi et al makes similar disclosures in U.S. Pat. No. 4,645,795, issued Feb. 24, 1987.

U.S. Pat. No. 4,797,440 to Schofield et al, issued Jan. 10, 1989, describes a thermoplastic polymeric organic medium in the presence of a lubricant and a processing additive containing a divalent aliphatic radical. Among the thermoplastic polymers disclosed by Schofield et al, are polyvinylchloride. The possible materials utilized as lubricants by Schofield et al include 12-hydroxy stearic acid, stearic acid, stearamide, a polyethylene wax, as well as zinc and calcium stearates. The stabilization of polyvinylchloride is taught in U.S. Pat. No. 4,338,226, issued Jul. 6, 1982, to Worschech et al. Various calcium and zinc fatty acids and polyol partial esters are disclosed. It is also disclosed by Worschech et at that high molecular weight complex esters may be utilized as lubricants and as well natural fats.

The stabilization of vinylchloride polymers is taught by Crochemore et at in U.S. Pat. No. 4,102,839, issued Jul. 25, 1978. The use of epoxidized soybean oil, a wax, calcium stearate and zinc stearate is disclosed by Crochemore for the processing of vinylchloride.

U.S. Pat. No. 3,951,883, issued Apr. 20, 1976, to Ruchlak, et al, discloses polyvinylchloride molding compositions. Tenaka et al, in U.S. Pat. No. 4,072,657, issued Feb. 7, 1978, discloses synthetic resins which include among others, vinylchloride-vinylacetate copolymers, and described as plasticizers therefore, fatty oils, and waxes.

U.S. Pat. No. 4,392,581, issued Jul. 12, 1983 to Itsubo et at describes vinylchloride resin compositions obtained from a mixed fatty acid ester of glycerin. U.S. Pat. No. 3,578,621 issued May 11, 1971 to Stapfer describes stearamide waxes which may be utilized for plastic processing.

Wilson, in U.S. Pat. No. 3,981,838 issued Sep. 21, 1976 describes various tri-carboxylic compounds which may be esterified and utilized in processing plastics. Wilson states that acid numbers under 2.5 are arbitrarily viewed as essentially tri-esters. Wilson further continues to state that acid numbers greater than that would correspond to a decrease in external lubricity.

Worschech in U.S. Pat. No. 3,875,069 describes lubricants for thermoplastic materials which are (A) mixed esters of aliphatic polyols, dicarboxylic acids and long chained aliphatic monocarboxylic acids, and (B) esters of the group of dicarboxylic acids and long chained aliphatic monofunctional alcohols; esters of long chained aliphatic monofunctional alcohols and long chained aliphatic monocarboxylic acids; and complete or partial esters of aliphatic polyols and long chained aliphatic monocarboxylic acids in a ratio of (A) to (B) of 1:3 to 9:1.

The manufacture of polyvinylchloride articles comprises a major segment of the plastic materials in use today. In particular, the polyvinylchloride articles with which the present invention is concerned, include siding for homes. To be useful as a siding, polyvinylchloride must exhibit low gloss and have high impact resistance. The impact resistance is important so that the siding will withstand weather. The low gloss is important so that the siding may be painted.

U.S. Pat. No. 4,487,874 issued Dec. 11, 1984 to Lindner discloses polycarbonate lubricants that were formed from the partial esterification of pentaerythritol. Tenaka et at in U.S. Pat. No. 4,072,657 issued Feb. 7, 1978 discloses synthetic resins which include vinylchloride-vinylacetate copolymers.

It is known from Lindner, U.S. Pat. No. 4,474,913 issued Oct. 2, 1984 that polyvinylchloride may be prepared through an extrusion process to form useful articles such as combs, spoons, siding, window frames, moldings, pipes, tubing and many other useful items. The polyvinylchloride is prepared in the form of a shaped article by mixing the polyvinylchloride, applying sufficient heat and/or mechanical pressure to transform the granular or powdered form of the polyvinylchloride into a plastic state. The polyvinylchloride in the plastic state is then fed through an extruder which is basically described as a screw device which receives the pulverant polyvinylchloride resin and such other necessary ingredients, and forces the resin through an orifice thereby forming the article.

It is known from the author's earlier U.S. Pat. No. 4,332,702 issued Jun. 1, 1982 that partial esters of pentaerythritol may be used as a lubricant in processing polyvinylchloride. It is currently known in the art that ethylene bis stearamide may be used as a lubricant, which when mixed with polyvinylchloride resin prior to extrusion will coat the extrusion device so that the polyvinylchloride does not adhere to the surfaces of the extruder. Ethylene bis stearamide has been found unsuitable in certain regards inasmuch as it is subject to degradation. The degradation is believed to occur at the amide linkage. During the degradation of ethylene bis stearamide it is theorized that the polyvinylchloride is damaged through the removal of chlorine molecule by the decomposing amide. The loss of the chlorine results in a rearrangement of the bond structure of the polyvinylchloride giving rise to unsaturation at the site where the chlorine atom was removed. The unsaturation leads to instability of the resin from sunlight.

U.S. Pat. No. 5,134,185 issued Jul. 28, 1992 and U.S. Pat. No. 6,069,195 issued May 30, 2000, both to Lindner, describe lubricant systems for polyvinylchloride, polyvinylchloride articles, and a method for manufacturing the same providing desirable properties for both internal and external lubricity for polyvinylchloride resins is disclosed. Also disclosed is the use of the lubricants disclosed herein in an extruder.

U.S. Pat. No. 5,414,035 issued to Lindner, et al. May 9, 1995 describes an external lubricant composition for calendered vinyl polymer. The external lubricant provides rigid vinyl polymer compositions having improved plate out resistance, clarity, release, and stability. The external lubricant comprises an effective amount for lubricating vinyl polymer of polyethylene having a Brookfield viscosity at a temperature of 150° C. of greater than about 85,000 centipoises and an acid number as determined by standardized titration of KOH of between about 5 and about 9. Sheets of the calendered vinyl polymer are used for blister packs and credit cards. David Hurwitz, in “The Use of Low Molecular Weight Polyethylene in Rigid PVC Lubrication”, Society of Plastics Engineers, 31st Annual Technical Conference, 349 (May 1973), discloses polyethylene useful in lubricating vinyl chloride polymer.

U.S. Pat. No. 5,426,144 to Lindner, et al., issued Jun. 20, 1995 describes an external lubricant composition for lead stabilized vinyl polymer. The external lubricant functions as both an external lubricant and a processing aid by speeding fusion and thus, obviates the need for a separate processing aid. The external lubricant comprises an effective amount for lubricating vinyl polymer of polyethylene having a Brookfield viscosity at a temperature of 150° C. of between about 1000 and about 100000 centipoises and an acid number as determined by standardized titration of KOH of between about 1 and about 40.

Lindner filed Jan. 14, 2002 U.S. patent application Ser. No. 10/047362 which describes polyvinylchloride processing, commonly by extrusion, which may be utilized to obtain high impact resistance and low gloss polyvinylchloride articles. U.S. Pat. No. 5,621,033 issued May 15, 1997 to Lindner describes a lubricating system for polyvinylchloride and other plastics having excellent metal release properties for the plastics industry.

Throughout the specification and claims, percentages and ratios are by weight, temperatures are in degrees Celsius, and pressures are in Kpa gauge unless otherwise indicated. To the extent that any of the references cited herein are applicable, they are hereby specifically incorporated by reference. Ranges and ratios given herein may be combined.

### SUMMARY OF THE INVENTION

The present invention describes a method for producing a polyvinylchloride article comprising the steps of:

operating an apparatus comprising a plurality of roller drums;

wherein a first roller drum is rotating clockwise;

wherein a second roller drum is rotating counterclockwise wherein a third roller drum is rotating clockwise;

wherein a fourth roller drum is rotating counterclockwise

passing a mixture of polyvinylchloride and a lubricant between opposing rotating surfaces of said first roller drum and said second roller drum;

wherein the mixture of polyvinylchloride and a lubricant are formed into a polyvinylchloride sheet by the action of said first roller drum and said second roller drum;

said polyvinylchloride sheet having an obverse side and a reverse side;

provided further that said polyvinylchloride sheet is passed between the opposing surfaces of the said third roller drum and the said second roller drum;

said third roller drum having an imprinted exterior surface, for when in use, imprinting the obverse surface of the said polyvinylchloride sheet thereby forming an obverse imprinted polyvinylchloride sheet;

provided further that said polyvinylchloride sheet is passed between the opposing surfaces of the said fourth roller drum and the said third roller drum;

said fourth roller drum having an imprinted exterior surface, for when in use, imprinting the reverse surface of the said obverse imprinted polyvinyl-chloride sheet thereby forming an obverse and reverse imprinted polyvinylchloride sheet;

wherein the mixture of polyvinylchloride and a lubricant are premixed into at a temperature of at least about 40° C.; and,

wherein the lubricant is a high density low acid value oxidized polyethylene.

The present invention also describes an oxidized polyethylene having a melting point of about 100 degrees C. to 140 degrees C.

The present invention further describes Oxidized polyethylene prepared by passing an oxygen containing fluid mixture through a liquid high-density polyethylene until such time as the high-density polyethylene is oxidized to a mixture of high-density oxidized polyethylene having 140° C. Brookfield viscosity is less than 100 centipose.

### BRIEF DESCRIPTION OF THE DRAWINGS

FIG. 1 is schematic view of an aspect of the present invention.

### DETAILED DESCRIPTION OF THE INVENTION

### Component A

Polyvinylchloride resins are made thru the polymerization of vinylchloride monomers. The polyvinylchloride resins obtained are solid materials usually in a particulate form. Polyvinylchloride has the distinct advantage of being able to be extruded into shaped articles that are rigid.

Typically, the polyvinylchloride article is obtained by extruding the polyvinylchloride resin through a twin screw extruder. The extruder masticates the pellets and through the use of heat the polyvinylchloride is obtained as a plastic material. The extruded polyvinylchloride is then fed to a molding or shaping device to obtain the polyvinylchloride article in the desired shape.

During the extrusion of polyvinylchloride, both heat and mechanical energy are applied to the extruder. The mechanical energy input to move the polyvinylchloride through the extruder is eventually present as heat energy in the resin. It is desirable that the polyvinylchloride in the extruder have present materials which function both as internal and external lubricants. An internal lubricant is a material which allows the polyvinylchloride to smoothly flow through the extruder. The smooth flow through the extruder is needed to minimize the energy input to the extruder and to achieve a constant processing rate. The external lubricating component is desirable to avoid having the polyvinylchloride adhere to the inside of the extruder, the die surfaces, or the shaping device.

The manner of masticating the polyvinylchloride is as previously suggested through the use of a twin screw extruder. However, any means may be utilized to prepare the polyvinylchloride in a plastic state. In particular, the invention utilizes polyvinylchloride pellets having a maximum dimension of 5 mm to 25 mm, preferably 6 mm to 12 mm.

### Component B

Component B, the product according to the present invention, is obtained by oxidizing high-density polyethylene with a source of oxygen such as ambient air at a sufficient temperature and for a sufficient time to meet the viscosity requirements set forth herein. The high-density oxidized polyethylene of the present invention has an acid value of about 3 to about 11 or less. The high-density oxidized polyethylene of the present invention has a 140° C. Brookfield viscosity of less than 100 centipose. Preferably, the Brookfield viscosity of the high-density oxidized polyethylene 140° C. is about 5 to about 75 centipose.

### Component Usage

The amount of component B utilized herein is typically about 0.01 to about 5, preferably 0.05 to about 4 weight parts per 100 parts of component A.

### Additional Components

Typically, many additional components are utilized in polyvinylchloride processing. Generally, any of the normally used components in polyvinylchloride processing which do not materially interfere with the functioning of the lubricant system and the desired properties of low gloss and high impact resistance may be utilized herein. For instance, an impact modifier such as Acryloid KM 334 available from Rohm & Haas may be utilized herein at from 1 to 10 weight parts per 100 parts of the polyvinylchloride resin. Fillers and pigments may also be utilized herein typically at from 3 to 20 weight parts per 100 parts of the polyvinylchloride resin. Stabilizers may be utilized herein to neutralize the hydrochloric acid which is generated on degradation of the polyvinylchloride resin. Typically, the stabilizers may be various cadmium, lead, or tin compounds. A preferred tin stabilizer in the present invention is Advisable™ 181. The stabilizers are used in an amount sufficient to neutralize the acid formed upon degradation of the polyvinylchloride. Typically, the stabilizer will be used at 0.3 to 1.0 parts per 100 parts of the polyvinylchloride resin.

### Processing

The components of the present invention are mixed together thoroughly and processed through an extruder. Typically, the extruder will achieve a temperature of 140 to 220, preferably 150 to 200° C. during the extrusion process.

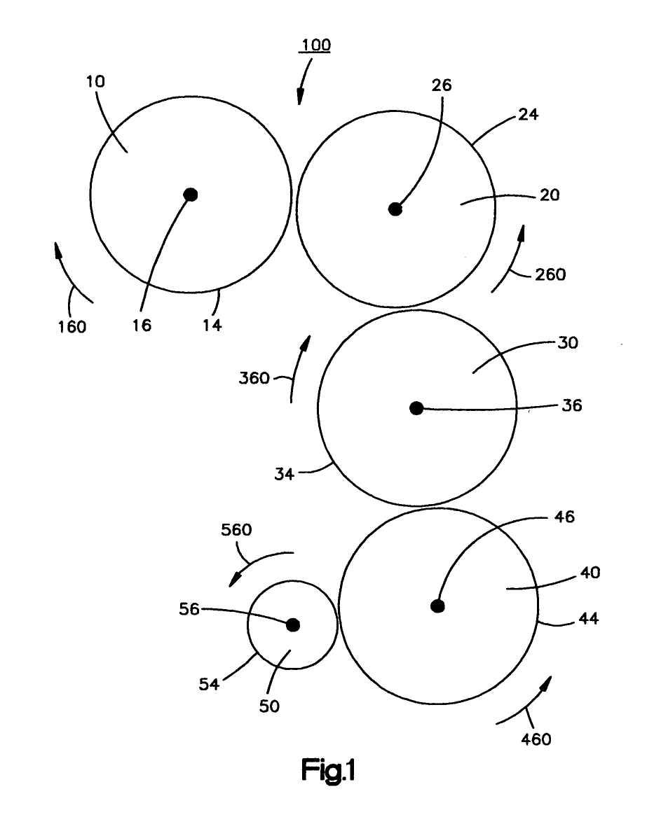

The present invention utilizes a system of what drums in conjunction with unique oxidized polyethylene lubricant of the present invention. As best seen FIG. 1, there is a first roller drum 10. The first roller drum 10 has an outer surface 14. The first roller drum 10 has a centerpoint 16.

A second roller drum 20 has an outer surface 24. The second roller drum 20 has a centerpoint 26. The first roller drum 10 is arranged with a second roller drum 20 such that the horizontal centerpoint 16 of the first roller drum 10 and the horizontal centerpoint 26 of the second roller drum 20 are in the same plane.

A third roller drum 30 has an imprinted outer surface 34. The third roller drum 30 has a centerpoint 36. The imprinted outer surface 34 is of any convenient design desired to be imprinted upon a sheet of a finished polyvinyl chloride article. The second roller drum 20 is arranged with the third roller drum 30 such that the vertical centerpoint 26 of the second roller drum 20 and the vertical centerpoint 36 of the second roller drum 30 are in the same plane.

A fourth roller drum 40 has an imprinted outer surface 44. The fourth roller drum 40 has a centerpoint 46. The imprinted outer surface 44 is of any convenient design desired to be imprinted upon a sheet of a finished polyvinyl chloride article. The third roller drum 30 is arranged with the fourth roller drum 40 such that the vertical centerpoint 36 of the third roller drum 30 and the vertical centerpoint 26 of the second roller drum 40 are in the same plane. The imprinted outer surface 44 of fourth roller drum 40 may have the same imprinting, or a different imprinting, then imprinted outer surface 34 of the third roller drum 30.

The roller drums 10, 20, 30, and 40 are each conveniently heated to a temperature of 100 degrees Celsius when in use.

A fifth roller drum 50 has a flat circular outer surface 54. The fifth roller drum 50 has a centerpoint 56. The fourth roller drum 40 is arranged with the fifth roller drum 50 such that centerpoint 46 of fourth roller drum 40 is horizontally in line with the centerpoint 56 of the roller drum 50.

In use, an arrow 100 shows the directional relationship of a mixture of polyvinylchloride and a lubricant made according to the present invention. The mixture is nipped, or forced between, the first roller drum 10 and the second roller drum 20. It is important in the present invention that the lubricant prevent excess buildup of the polyvinylchloride on each of the roller drum surfaces. The first roller drum 10 rotates clockwise as shown by the arrow 160. The second letter from 20 rotates counterclockwise as shown by the arrow 260.

The mixture exits the first roller drum 10 and the second roller drum 20 is taken up by the third roller drum 30. The third roller drum 30 rotates in a clockwise fashion as shown by the arrow 360. In the nipped between the second roller drum 20 and the third roller drum 30 the imprinted surface 34 imprints a design on the polyvinylchloride. For simplicity, the foregoing is referred to as obverse imprinting.

The obverse imprinted mixture is then nipped between the outer surface 34 of the roller drum 30 at the outer surface 44 of the fourth roller drum 40. The fourth roller drum 40 rotates in a counterclockwise direction as shown by the arrow 460. As of the outer surface 44 of the roller drum 40 is imprinted on the reverse the obverse imprinted mixture will when it is passed between the outer surface 34 and outer surface 44 will be imprinted on the reverse side.

The material which is now imprinted on the obverse and reverse sides is then taken up by the roller drum 50. The roller drum 50 is cooled to a substantially lower temperature than the roller drums 10, 20, 30, and 40. The roller drum 50 rotates counterclockwise in the direction show in my arrow 560. Typically, the temperature differential is about 20 to 40 degrees Celsius. The roller drum 50 aids in use the temperature of the finished polyvinyl chloride article.

The first roller drum, the second roller drum, the third roller drum, and the fourth roller drum surfaces are maintained at a temperature of at least about 100° C.

In the present invention the lubricant is useful in avoiding buildup on the surfaces of the roller drums. The practical effect on avoiding buildup is to ensure that the processing of the roller drums is effective and not costly with respect to energy usage. In the present invention each of the first roller drum 10, the said second roller drum 20, the third roller drum 30, and the fourth roller drum 40 surfaces are exposed to the atmosphere. The particularly oxidized polyethylene described herein is effective without undergoing substantial oxidation on the roller drum surfaces thus leading to greater energy cost and down time to clean the surfaces of the roller drums.

As seen in the table, the product of the present invention in the amounts shown is effective and maintaining a desirable fusion time, maximum torque, and the equilibrium torque. Excessive plate out of the lubricant and polyvinylchloride is avoided. The Brabender fusion time demonstrates that the product of the present invention will have excellent fusion characteristics when compared to the other products shown in the appended table.

What is claimed is:

1. A method for producing a polyvinylchloride article comprising the steps of:
operating an apparatus comprising a plurality of roller drums;
wherein a first roller drum is rotating clockwise;
wherein a second roller drum is rotating counterclockwise
wherein a third roller drum is rotating clockwise;
wherein a fourth roller drum is rotating counterclockwise
passing a mixture of polyvinylchloride and a lubricant between opposing rotating surfaces of said first roller drum and said second roller drum;
wherein the mixture of polyvinylchloride and a lubricant are formed into a polyvinylchloride sheet by the action of said first roller drum and said second roller drum;
said polyvinylchloride sheet having an obverse side and a reverse side;
provided further that said polyvinylchloride sheet is passed between the opposing surfaces of the said third roller drum and the said second roller drum;
said third roller drum having an imprinted exterior surface, for when in use, imprinting the obverse surface of the said polyvinylchloride sheet thereby forming an obverse imprinted polyvinylchloride sheet;
provided further that said polyvinylchloride sheet is passed between the opposing surfaces of the said fourth roller drum and the said third roller drum;
said fourth roller drum having an imprinted exterior surface, for when in use, imprinting the reverse surface of the said obverse imprinted polyvinyl-chloride sheet thereby forming an obverse and reverse imprinted polyvinylchloride sheet;
wherein the mixture of polyvinylchloride and a lubricant are premixed into at a temperature of at least about 40° C.; and,
wherein the lubricant is a high density low acid value oxidized polyethylene.

2. The method of claim 1 wherein the high-density oxidized polyethylene has an acid value of 11 or less.

3. The method of claim 1 wherein the mixture of the polyvinylchloride and the lubricant is substantially homogeneous mass.

4. The method of claim 1 wherein the high-density oxidized polyethylene has an acid value of about 3 to about 11 or less.

5. The method of claim 1 wherein the 140° C. Brookfield viscosity of the high-density oxidized polyethylene is less than 100 centipose.

6. The method of claim 1 wherein the high-density oxidized polyethylene has an acid value of about 3 to about 10.

7. The method of claim 1 wherein the Brookfield viscosity of the high-density oxidized polyethylene 140° C. is about 5 to about 75 centipose.

8. The method of claim 1 wherein each of the said first roller drum, the said second roller drum, the said third roller drum, and the said fourth roller drum surfaces are maintained at a temperature of at least about 100° C.

9. The method of claim 1 wherein each of the said first roller drum, the said second roller drum, the said third roller drum, and the said fourth roller drum surfaces are exposed to the atmosphere.

10. The method of claim 1 wherein the apparatus further comprises a fifth roller drum rotating clockwise, the said fifth roller drum having a surface opposed to the said? surface of the said fourth roller drum in a relationship to permit the said surface of the fifth roller drum to receive the obverse and reverse imprinted polyvinylchloride sheet.

11. The method of claim 1 wherein the apparatus further comprises a fifth roller drum rotating clockwise, the said fifth roller drum having a surface opposed to the said surface of the said fourth roller drum in a relationship to permit the said surface of the fifth roller drum to receive the obverse and reverse imprinted polyvinylchloride sheet, provided further that the surface of the said fifth roller drum is at a lower temperature than the surface of the said fifth roller drum.

12. An oxidized polyethylene having a melting point of about 100 degrees C. to 140 degrees C.

13. The oxidized polyethylene of claim 12 wherein the 140° C. Brookfield viscosity is less than 100 centipose.

14. The oxidized polyethylene of claim 12 having an acid value of 11 or less.

15. The oxidized polyethylene of claim 12 having an acid value of about 3 to about 11 or less.

16. The oxidized polyethylene of claim 12 further comprising polyvinylchloride.

17. A composition comprising oxidized polyethylene prepared by passing an oxygen containing fluid mixture through a liquid high-density polyethylene until such time as the high-density polyethylene is oxidized to a mixture of high-density oxidized polyethylene having 140° C. Brookfield viscosity is less than 100 centipose.

18. The oxidized polyethylene of claim 17 further comprising polyvinylchloride.
